(19) United States
(12) Patent Application Publication
(10) Pub. No.: US 2007/0230343 A1
(43) Pub. Date: Oct. 4, 2007

(54) System and method for translating messages

(75) Inventor: Chu-feng Lien, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,875

(22) Filed: Oct. 17, 2006

(30) Foreign Application Priority Data
Mar. 31, 2006 (TW) 95111403

(51) Int. Cl. H04L 12/56

(52) U.S. Cl. 370/235

(57) ABSTRACT

A system for translating messages includes a local exchange (20), a terminal (30), and an access node (10) connecting the local exchange and the terminal. The access node includes a translation system (100) connectable to the local exchange, and a terminal management module (120) connectable to the terminal and the translation system. The translation system translates between V5 messages and text messages. The terminal management module translates between the text messages and signals from the terminal.

### FIELD OF THE INVENTION

The invention relates to message translation systems, and particularly to a message translation system and a method for translating a V5 message/text message to a text message/V5 message.

### DESCRIPTION OF RELATED ART

In prior art, a method is known that can be used to connect a terminal to a local exchange, by connecting the terminal to the local exchange via a separate access network.

Open interfaces (V5.1 and V5.2) between an access network, preferably an access node, and a local exchange are defined in the ETSI (European Telecommunications and Standards Institute) standards of the ETS 300 324 and ETS 300 347 series. V5 interfaces enable terminals belonging to a physically separate access network to be connected to a telephone exchange using a standard interface. Often, the local exchange sends a V5 message to the access node, and the access node translates the V5 message to a signal usable by the terminal, and sends the signal to the terminal.

However, because the V5 message is a binary-code message, when there is a malfunction in the access node, a network administrator must be able to identify the binary-code message to restore the malfunction. Consequently, it is very inconvenient for the network administrator to immediately understand the binary-code message.

Therefore, a heretofore unaddressed need exists in the industry to overcome the aforementioned deficiencies and inadequacies.

### SUMMARY OF THE INVENTION

An exemplary embodiment of the invention provides a system for translating messages. The system includes a local exchange, a terminal, and an access node connecting the local exchange and the terminal. The access node includes a translation system connectable to the local exchange, and a terminal management module connectable to the terminal and the translation system. The translation system translates between V5 messages and text messages. The terminal management module translates between the text messages and signals from the terminal.

Another exemplary embodiment of the invention provides a method for translating between V5 messages and text messages in a network system comprising a terminal, a local exchange, and an access node. The method includes steps of: receiving the V5 messages from the local exchange; receiving signals from the terminal; providing a mapping list comprising mapping relationships between the V5 messages and the text messages; translating between the V5 messages and the text messages; and translating between the text messages and the signals.

Other advantages and novel features will become more apparent from the following detailed description when taken in conjunction with the accompanying drawings, in which:

### BRIEF DESCRIPTION OF THE DRAWINGS

FIG. 1 is a schematic diagram of a network system of an exemplary embodiment of the invention;

FIG. 2 is a block diagram of a translation system of the network system of FIG. 1;

FIG. 3 is a flowchart of a method for translating a V5 message to a text message of an exemplary embodiment of the invention; and

FIG. 4 is a flowchart of a method for translating the text message to the V5 message of an exemplary embodiment of the invention.

### DETAILED DESCRIPTION OF THE INVENTION

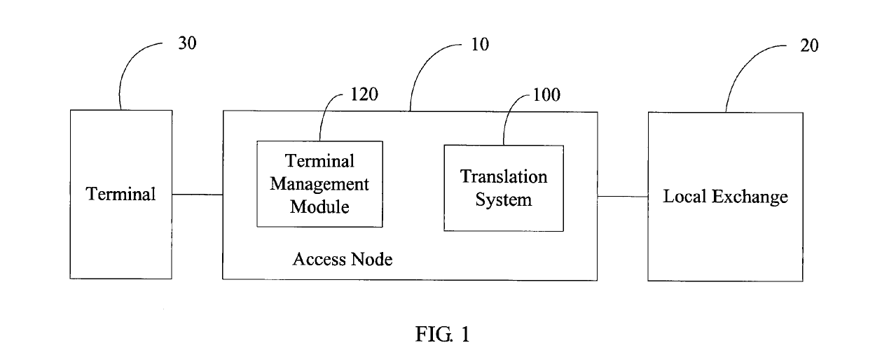

FIG. 1 is a schematic diagram of a network system of an exemplary embodiment of the invention. The network system comprises network devices such as a local exchange 20, an access node 10, and a terminal 30. The terminal 30 is connected to the local exchange 20 via the access node 10. The local exchange 20 sends V5 messages to the access node 10. In the access node 10, the V5 messages are translated and transmitted to the terminal 30. In the exemplary embodiment, the terminal 30 may be a Public Switched Telephone Network (PSTN) terminal or Integrated Services Digital Network (ISDN) terminal. Each of the V5 messages comprises V5 signaling and a V5 payload. In the exemplary embodiment, the V5 payload comprises a network layer address.

The access node 10 comprises a translation system 100 and a terminal management module 120. In the translation system 100, the V5 messages are translated to text messages, and the text messages are transmitted to the terminal management module 120. The terminal management module 120 translates the text messages to signals which the terminal 30 can identify, and transmits the signals to the terminal 30. Correspondingly, the terminal management module 120 receives signals from the terminal 30, and translates the signals to the text messages, then sends the text messages to the translation system 100. The translation system 100 translates the text messages to the V5 messages, and sends the V5 messages to the local exchange 20. In the exemplary embodiment, the signals may be PSTN signals, ISDN signals, and so on. Each of the text messages comprises text signaling and a text payload. In the exemplary embodiment the text payload comprises a slot number and a port number.

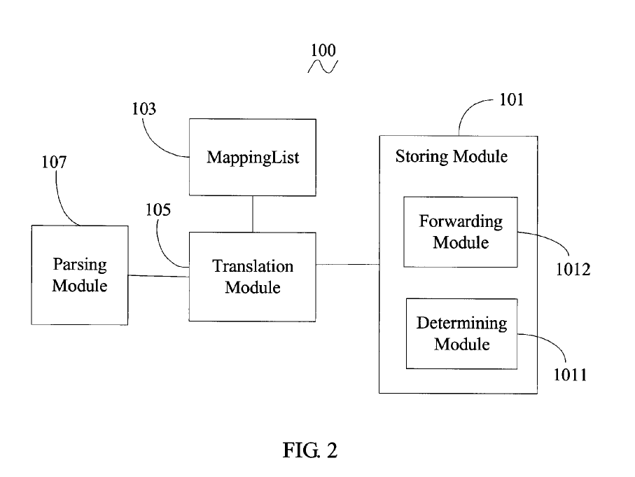

FIG. 2 is a block diagram of the translation system 100 of FIG. 1. The translation system 100 comprises a storing module 101, a mapping list 103, a translation module 105, and a parsing module 107.

The storing module 101 is used for temporarily storing the V5 messages, and comprises a forwarding module 1012 and a determining module 1011. The forwarding module 1012 receives the V5 messages from the local exchange 20, and sends the V5 messages to the determining module 1011. The determining module 1011 determines whether the V5 messages need to be sent to the terminal 30. If the V5 messages need to be sent to the terminal 30, the determining module 1011 sends the V5 messages to the translation module 105. Conversely, if the V5 messages do not need to be sent to the terminal 30, the V5 messages are stored in the storing module 101. The forwarding module 1012 receives the V5 messages from the translation module 105, and sends the V5 messages to the local exchange 20.

The mapping list 103 comprises mapping relationships between the V5 message and the text message. Each of the mapping relationships comprises a signaling mapping relationship between the V5 signaling and the text signaling, and a payload mapping relationship between the network layer address and the slot number and the port number. The signaling mapping relationships are partly shown in table 1. As shown in table 1, V5 signaling “1111111” indicates polarity normal, and corresponds to text signaling “REV−”; V5 signaling “1111110” indicates polarity reverse, and corresponds to text signaling “REV+”; and V5 signaling “000100” indicates disconnect, and corresponds to text signaling “DISC”.

TABLE 1

| V5 signaling | text signaling |
|---|---|
| 1111111 | REV− |
| 1111110 | REV+ |
| 0001000 | DISC |

The payload mapping relationships are partly shown in table 2. As shown in table 2, a network layer address “1” corresponds to a slot number “1” and a port number “1”; a network layer address “2” corresponds to a slot number “1” and a port number “2”; a network layer address “100” corresponds to a slot number “3” and a port number “4”; a network layer address “101” corresponds to a slot number “3” and a port number “5”, and so on.

TABLE 2

| network layer address | slot number | port number |
|---|---|---|
| 1 | 1 | 1 |
| 2 | 1 | 2 |
| . . . | . . . | . . . |
| 100 | 3 | 4 |
| 101 | 3 | 5 |
| . . . | . . . | . . . |

The translation module 105 translates the V5 signaling to the text signaling according to the signaling mapping relationships in the mapping list 103, and vice versa. For example, when the translation module 105 receives the V5 signaling from the storing module 101, the translation module 105 firstly searches the signaling mapping relationships in the mapping list 103, and translates the V5 signaling to the text signaling according to the signaling mapping relationships, then sends the text signaling to the parsing module 107. When the translation module 105 receives the text signaling from the parsing module 107, the translation module 105 firstly searches the signaling mapping relationships in the mapping list 103, and translates the text signaling to the V5 signaling according to the signaling mapping relationships, then sends the V5 signaling to the storing module 101. Correspondingly, the translation module 105 translates the network layer addresses to the slot numbers and the port numbers, or translates the slot numbers and the port numbers to the network layer addresses according to the payload mapping relationships in the mapping list 103 using the same way as detailed above. In this way, in the translation module 105, the V5 messages and the text messages are translated reciprocally.

The parsing module 107 is used for parsing the text message received from the translation module 105. In the exemplary embodiment, the parsing module 107 adds an identifier to a segment of each text message received from the translation module 105. The segment of the text message comprises a request for notification (RQNT), and an audit endpoint (AUEP). Then, the parsing module 107 sends the identified text messages to the terminal management module 120. When receiving the text messages from the terminal management module 120, the parsing module 107 deletes the identifier of each text message, and sends the text message to the translation module 105.

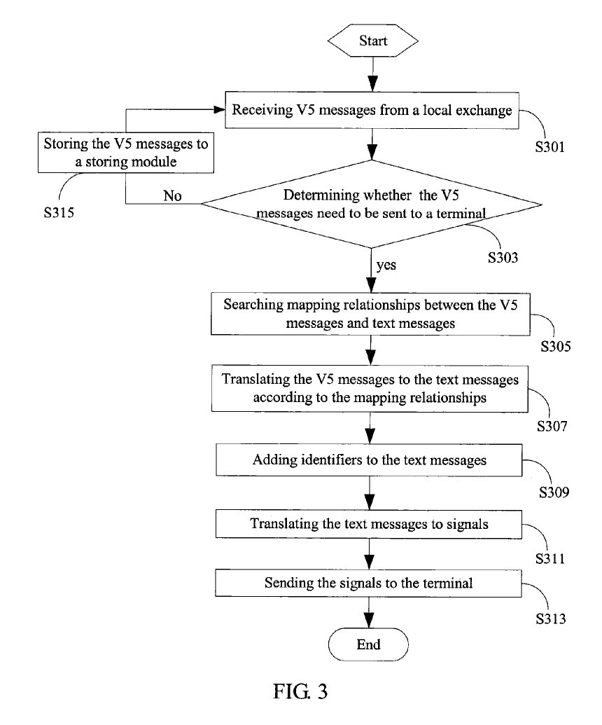

FIG. 3 is a flowchart of a method for translating V5 messages to text messages of an exemplary embodiment of the invention.

In step S301, the storing module 101 receives the V5 messages from the local exchange 20.

In step 303, the storing module 101 determines whether the V5 messages need to be sent to the terminal 30.

In step 305, if the V5 messages need to be sent to the terminal 30, the storing module 101 sends the V5 messages to the translation module 105. The translation module 105 searches the mapping relationships between the V5 messages and the text messages in the mapping list 103.

In step 307, the translation module 105 translates the V5 messages to the text messages according to the mapping relationships, and sends the text messages to the parsing module 107.

In step 309, the parsing module 107 adds an identifier to each text message, and sends the identified text messages to the terminal management module 120.

In step 311, the terminal management module 120 translates the identified text messages to signals, and sends the signals to the terminal 30. In the exemplary embodiment, each of the signals may be PSTN signal, ISDN signal, and so on.

In step 313, if the V5 message does not need to be sent to the terminal management module 120, the V5 messages are stored in the storing module 101.

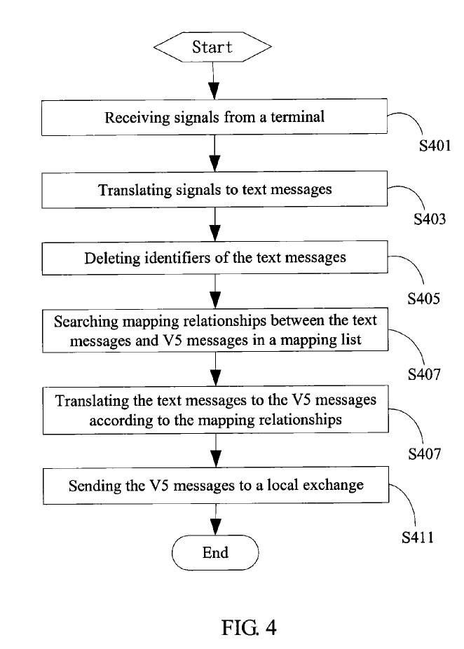

FIG. 4 is a flowchart of a method for translating the text messages to the V5 messages of an exemplary embodiment of the invention.

In step 401, the terminal management module 120 receives signals from the terminal 30.

In step 403, the terminal management module 120 translates the signals to the text messages, sends the text messages to the parsing module 107. In the exemplary, each of the signals may be PSTN a signal, ISDN signal, and so on.

In step 405, the parsing module 107 deletes the identifier of each text message, and sends the test messages to the translation module 105.

In step 407, the translation module 105 searches mapping relationship between the V5 message and the text message in the mapping list 103.

In step 409, the translation module 105 translates the test messages to the V5 messages according to the mapping relationships, and sends the V5 messages to the storing module 101.

In step 411, the storing module 101 transmits the V5 message to the local exchange 30.

Because the text messages are transmitted through the access node 10, when there is a malfunction in the access node 10, a network administrator can restore the malfunction via the text messages without identifying binary-code messages. It is convenient for the network administrator.

While embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A system for translating messages, comprising:
a local exchange;
a terminal; and
an access node connecting the local exchange and the terminal, the access node comprising:
a translation system connectable to the local exchange, the translation system translating between V5 messages and text messages; and
a terminal management module connectable to the terminal and the translation system, the terminal management module translating between the text messages and signals from the terminal.

2. The system as claimed in claim 1, wherein each of the V5 messages comprises V5 signaling and a V5 payload.

3. The system as claimed in claim 2, wherein each of the text messages comprises text signaling and a text payload.

4. The system as claimed in claim 3, wherein the translation system further comprises a mapping list comprising mapping relationships between the V5 messages and the text messages.

5. The system as claimed in claim 4, wherein each of the mapping relationships comprises a signaling mapping relationship between the V5 signaling and the text signaling, and a payload mapping relationship between the V5 payload and the text payload.

6. The system as claimed in claim 4, wherein the translation system further comprises a translation module for translating between the V5 messages and the text messages according the mapping relationships in the mapping list.

7. The system as claimed in claim 1, wherein the translation system comprises a storing module for storing the V5 messages.

8. The system as claimed in claim 1, wherein the storing module comprises a forwarding module for receiving the V5 messages from the local exchange.

9. The system as claimed in claim 1, wherein the storing module further comprises a determining module for determining whether the V5 messages need to be sent to the terminal.

10. The system as claimed in claim 1, wherein the translation system further comprises a parsing module for parsing the text messages.

11. A method for translating between V5 messages and text messages in a network system comprising a terminal, a local exchange and an access node, the method comprising:
receiving the V5 messages from the local exchange;
receiving signals from the terminal;
providing a mapping list comprising mapping relationships between the V5 messages and the text messages;
translating between the V5 messages and the text messages; and
translating between the text messages and the signals.

12. The method as claimed in claim 11, further comprising a step of determining whether the V5 messages need to be sent to the terminal.

13. The method as claimed in claim 12, further comprising a step of searching the mapping relationships in the mapping list if the V5 messages need to be sent to the terminal.

14. The method as claimed in claim 12, further comprising a step of storing the V5 messages in a storing module if the V5 messages need not to be sent to the terminal.

15. The method as claimed in claim 11, further comprising a step of parsing the text messages.

16. The method as claimed in claim 15, wherein each of the V5 messages comprises V5 signaling and a V5 payload.

17. The method as claimed in claim 16, wherein each of the text messages comprises text signaling and a text payload.

18. The method as claimed in claim 17, wherein each of the mapping relationships comprises a signaling mapping relationship between the V5 signaling and the text signaling, and a payload mapping relationship between the V5 payload and the text payload.

19. A method for transmitting messages between network devices, comprising the steps of:
transmitting a first type of messages which is machine-readable between a first network device and a second network device;
transmitting communicable signals between said second network device and a third network device; and
translating said first type of messages to a second type of messages, which is human-readable, and vice versa in said second network device according to a mapping relationship between said first and second types of messages when said second type of messages is further translated to said signals for transmission between said second network device and said third network device, and vice versa.

20. The method as claimed in claim 19, further comprising a step of adding identifiers to said second type of messages before said second type of messages is translated to said signals, and deleting said identifiers from said second type of messages after said signals are translated to said second type of messages.
